(19) United States
(12) Patent Application Publication
(10) Pub. No.: US 2026/0205395 A1
(43) Pub. Date: Jul. 16, 2026

(54) METHODS AND DEVICES FOR MEASURING NETWORK LATENCY

(71) Applicant: EQUINIX INC., Redwood City, CA (US)

(72) Inventors: Syed Hashim Iqbal, Mountain View, CA (US); Bepsy Paul, San Jose, CA (US)

(73) Assignee: EQUINIX INC., Redwood City, CA (US)

(21) Appl. No.: 19/017,009

(22) Filed: Jan. 10, 2025

(51) Int. Cl. H04L 43/0852; H04J 3/06; H04L 9/40

(52) U.S. Cl. CPC H04L 43/0852; H04J 3/0638; H04L 63/1425; H04L 63/1441

(57) ABSTRACT

A method of determining latency in a network includes providing a plurality of nodes, the plurality of nodes including at least one origination node and at least one destination node; synchronizing clocks in the plurality of nodes; transmitting a packet from the origination node to the destination node; time stamping the packet with clock times from the synchronized clocks as the packet passes through nodes as the packet passes from the origination node to the destination node; and analyzing the stamped times to determine hop-to-hop times taken by the packet as the packet travelled from the origination node to the destination node. Other methods, devices, and systems are disclosed.

### FIELD OF THE DISCLOSURE

The present disclosure relates generally to determining latency in networks for data communications. In particular, but not by way of limitation, the present disclosure relates to systems, methods, and apparatuses for determining specific locations of latency within networks.

### BACKGROUND

Networks transfer data between origination nodes and destination nodes. When an origination node transmits data to a destination node in a network, the data may be routed on one of many different paths. The paths typically have a plurality of nodes (e.g., routers and switches) connected between the origination node and the destination node. Devices in the network may determine the fastest path for data transmissions between the origination node and the destination node. For example, two paths may be connected between the origination node and the destination node. Initially, devices in the network may determine that the first path is the fastest (lowest latency) at a particular time. As network congestion changes, the first path may develop issues that cause data transmissions in the first path to become slow (e.g., high latency), which may adversely affect applications relying on data transmissions between the origination node and the destination node. Therefore, a need exists for methods and devices that monitor and report network latency so devices in the networks can rout data efficiently.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some embodiments of the disclosure may be characterized as methods of determining latency in networks. A method includes providing a plurality of nodes, the plurality of nodes including at least one origination node and at least one destination node; synchronizing clocks in the plurality of nodes; transmitting a packet from the origination node to the destination node; time stamping the packet with clock times from the synchronized clocks as the packet passes through nodes from the origination node to the destination node; and analyzing the stamped times to determine hop-to-hop times taken by the packet as the packet travelled from the origination node to the destination node.

Other embodiments of the disclosure may also be characterized as methods of determining latency in networks. A method includes providing a plurality of nodes including an origination node and one or more destination nodes; synchronizing clocks in the plurality of nodes; transmitting a plurality of packets from the origination node to the one or more destination nodes; time stamping the plurality of packets with clock times from the synchronized clocks as the packet passes through nodes as the plurality of packets travel from the origination node to the one or more destination nodes; and analyzing the stamped times to determine hop-to-hop times taken by the plurality of packets as the plurality of packets travelled from the origination node to the one or more destination nodes.

Other embodiments of the disclosure can be characterized as processing nodes for monitoring networks. A processing node may include a synchronized time generator configured to synchronize nodes in a network to a global time reference; a packet time stamp generator configured to cause one or more nodes of the network to time stamp one or more packets based on the global time reference as the one or more packets travel throughout the network; and an analyzer configured to determine hop-to-hop time between at least one pair of nodes based at least in part on the time stamps.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings.

FIG. 1 illustrates a flowchart of a method of measuring latency in a network according to one or more embodiments.

FIG. 2 illustrates a block diagram of a network wherein the method of FIG. 1 is implemented to determine latency according to one or more embodiments.

FIG. 3 illustrates a block diagram of the processing node of FIG. 2 according to one or more embodiments.

FIG. 4 illustrates a detailed embodiment of the network of FIG. 2 according to one or more embodiments.

FIG. 5 illustrates the network of FIG. 4 with an extra node, wherein the network may detect packets maliciously diverted to the extra node according to one or more embodiments.

FIG. 6 illustrates the network of FIG. 4 with an extra node, wherein the network may detect data transferred to the extra node according to one or more embodiments.

FIG. 7 illustrates a flowchart of a method of determining latency in a network according to one or more embodiments.

FIG. 8 illustrates a flowchart of another method of determining latency in a network according to one or more embodiments.

### DETAILED DESCRIPTION

Preliminary note: the flowcharts and block diagrams in the following figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block diagrams may occur out of the order noted in the figures. For example, two blocks shown in succession may, in fact, be executed substantially concurrently, or the blocks may sometimes be executed in the reverse order, depending upon the functionality involved. It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups but do not preclude the presence or addition of one or more other features, integers, steps, operations, elements, components, and/or groups thereof. As used herein, the term “and/or” includes any and all combinations of one or more of the associated listed items.

It is understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The methods described in connection with the embodiments disclosed herein may be embodied directly in hardware, in processor-executable code encoded in a non-transitory tangible processor readable storage medium, or in a combination of the two. As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Network engineering, computer networks, and data transmission systems focus on the efficient transmission of data packets (sometimes referred to herein simply as “packets”) across networks, monitoring and managing network traffic, and ensuring optimal network performance. One of the objectives of network engineering is the measurement of network latency, which is the time it takes for a packet to travel from a source (e.g., an origination node) to a destination (e.g., a destination node). Latency is a factor in understanding the performance of networks and identifying any potential issues with networks.

Some conventional methods for measuring network latency include using sFlow (Sampled Flow) technology, which is a standard for collecting and analyzing network traffic information. sFlow monitors networks by sampling a small percentage of the network traffic and providing a representative view of the overall network activity. sFlow technology does not provide indications of exact network activity at exact locations of activity in the network. There are two main sampling methods used in sFlow, packet-based sampling and time-based sampling. Packet-based sampling involves sampling one packet out of a specified number of packets from an interface (e.g., a node) enabled for sFlow technology. Time-based sampling, on the other hand, involves sampling interfaces at specified intervals.

The methods and devices described herein overcome many deficiencies with conventional methods and devices used to measure latency in networks. Conventional sFlow sampling methods and devices only provide an approximate representation of network activity, which may cause inaccurate latency measurements, especially for infrequent packet flows. The methods and devices described herein overcome this inaccuracy issue by novel sampling mechanisms that provide accurate latency measurements of entire networks with little or no overhead on the network.

In addition to the foregoing, conventional sFlow technology does not provide a mechanism for measuring the exact path taken by packets used by certain applications, which can be useful in understanding network performance. The methods and devices described herein overcome this issue by providing a stamp/flow identification mechanism applied to packets to trace paths taken by the packets and the actual latency encountered by the packets as the packets travel throughout the networks. Furthermore, conventional sFlow methods and devices do not provide a mechanism for detecting anomalies in latency in paths, which can be indicative of security risks. The methods and devices disclosed herein overcome this issue by providing a mechanism configured to analyze paths taken by packets on a hop-by-hop basis, which can be used to identify security risks when latency or path anomalies are detected.

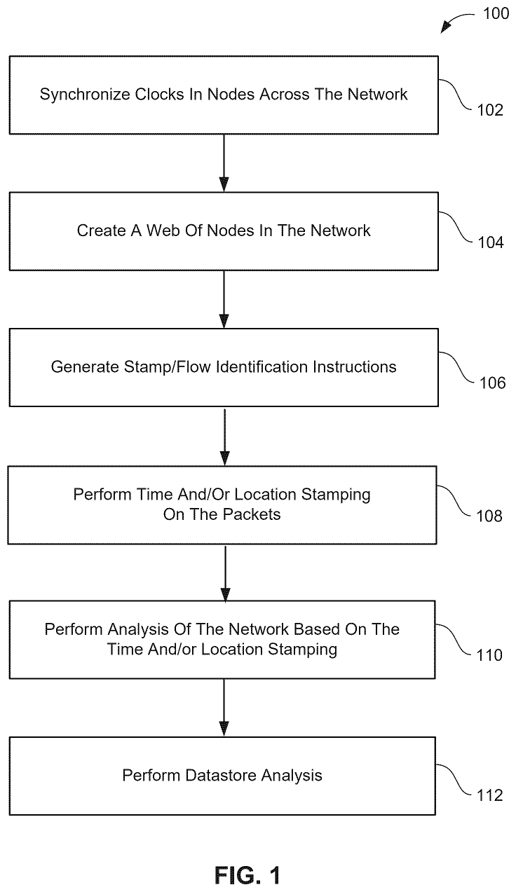

Reference is made to FIG. 1, which illustrates a flowchart describing a method 100 of determining latency in networks as described herein. The method 100 may commence with operational block 102, which includes synchronizing clocks in nodes across the network. Nodes in the network include devices that generate, transmit, transfer, and/or receive packets. These devices include, but are not limited to, routers, bridges, servers, switches, and devices associated with Internet of things (IoT). In some embodiments, the synchronizing may use Network Time Protocol (NTP) or Precision Time Protocol (PTP) to synchronize clocks in the nodes. The synchronizing ensures that all nodes in the network measure time with relative to the same reference time (e.g., a global clock time), which reduces errors in latency calculations. Thus, all the clocks in the nodes may be synchronized to a single global time reference.

In operational block 104, a web of nodes that are to time stamp and/or location stamp packets is created. The web of nodes may, as an example, include a portion of a network. In other embodiments, the web of nodes may include an entire network, such as a network in a data center. In other embodiments, the web of nodes may include certain paths between origination nodes and destination nodes in the network.

Stamp/flow identification instructions may be generated in operational block 106. The instructions may enable one or more nodes to stamp packets with a time stamp and/or a location stamp. The stamps can be used to trace the actual latency traversing each of the individual nodes of the network path, which may provide an exact latency and the paths taken by the packets. For example, the stamps may include the node processing the packet and the time when the packet entered and/or exited the node. In some embodiments, the stamp may include other processing times taken within the nodes. In some embodiments, packets transmitted via connectionless protocols as described herein may be stamped, which enables identification of paths taken by these packets and times when these packets interacted with the nodes.

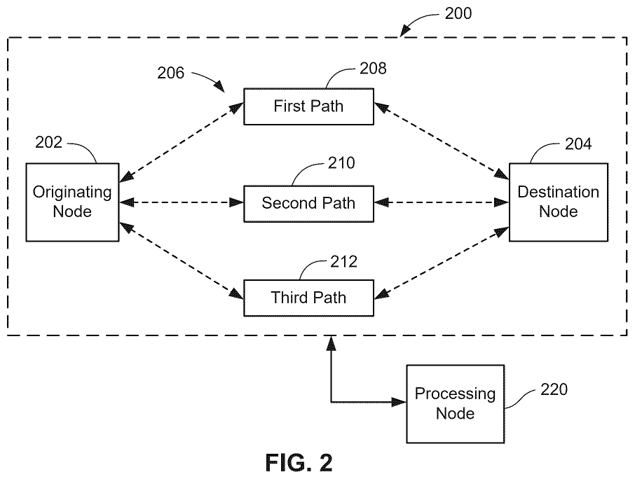

In operational block 108, time and/or location stamping of the packets is performed. The packets traversing the web of nodes may be stamped with the time they interacted with nodes per the instructions from operational block 106. The locations or identifications of the nodes may also be stamped on the packets. The time and/or location information may be transmitted to a processing node (e.g., processing node 220—FIG. 2) as described herein. Stamping the data on the packets may include appending data to the packets.

In operational block 110, an analysis of the network based on the time and/or location stamping may be performed, such as by the processing node 220 (FIG. 2). In some embodiments, a hop-by-hop analysis may be performed to determine exact locations of latencies in the network. A hop includes a node or other location in the network where a time and/or location was stamped on the packets. The analysis may include analyzing the collected stamps on a hop-to-hop basis to identify anomalies in latency or in the paths taken by the packet(s). In some embodiments, this analysis provides a mechanism for detecting security risks. For example, anomalies in latency or the paths taken by the packets can be indicative of a security breach. In some embodiments, security breaches may be caused by data being diverted to unscrupulous nodes, which may be identified as a change in the path taken by packets or a change in latency in a specific location in the network.

In some embodiments, an analysis of a datastore that stores data from the stamps may be performed in operational block 112 and may be performed in coordination with operational block 110. The datastore analysis may include storing at least some of the stamp data in a datastore and performing a more comprehensive analysis of the network. For example, an application specifically programmed to analyze the latency and/or location data may be utilized. The program may cause packets to be routed throughout the network to determine latency. The program may also identify possible security issues based on changes in latency and/or paths taken by the packets.

Additional reference is made to FIG. 2, which illustrates a block diagram of an example of a network 200. In some embodiments, the network 200 illustrated in FIG. 2 may be a portion of a larger network. The network 200 includes an origination node 202 and a destination node 204 with a plurality of paths 206 (e.g., data paths) linking the origination node 202 and the destination node 204. The paths 206 are referred to individually as a first path 208, a second path 210, and a third path 212. Although the paths 206 are shown being separate and individual data paths, portions of the paths 206 may overlap. For example, some nodes in the first path 208 may also be in the second path 210 and/or the third path 212. The network 200 is illustrated in FIG. 2 as having a single destination node 204. In other embodiments, the network 200 may have one or more origination nodes and/or one or more destination nodes.

The network 200 may include a processing node 220 or may be in communication with (e.g., coupled to) a processing node. The processing node 220 may be in communication with nodes in the paths 206 including the origination node 202 and/or the destination node 204. The processing node 220 may transmit instructions to devices in the network 200 and may collect data stamped to the packets, such as latency data and location data related to paths taken by the packets as described herein. Some embodiments of the devices and methods described herein store the stamped data in a datastore, which may be in the processing node 220. The processing node 220 may process the data to identify anomalies in the network 200. Because the data may be processed outside the network 200, the processing node 220 may provide a more comprehensive analysis of the network performance than conventional methods and devices and may eliminate the need for additional processing on or by the network nodes.

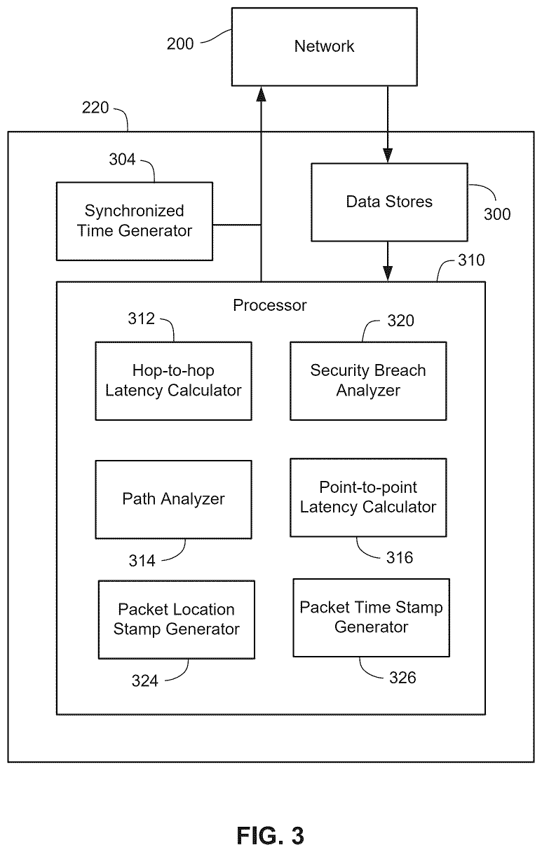

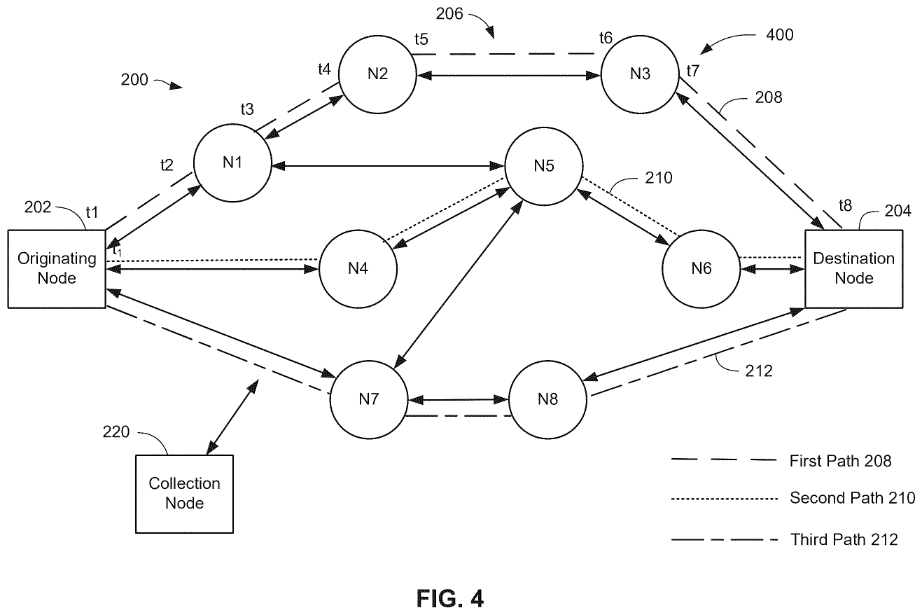

Additional reference is made to FIG. 3, which illustrates a block diagram of an embodiment of the processing node 220. In the embodiment of FIG. 3, the processing node 220 may be connected to the network 200, but may be considered being outside the network 200 because, in some embodiments, the processing node 220 may not transfer packets between nodes. Rather, the processing node 220 may send instructions to nodes (e.g., nodes 400—FIG. 4) of the network 200 that causes the nodes to perform the functions described herein. The processing node 220 may be implemented as a plurality of different devices, such as processors and/or servers. Thus, the modules within the processing node 220 described herein may be implemented in a plurality of different processing devices.

The processing node 220 may include a data store 300 configured to store the stamped data, which may include information pertaining to packets that are transmitted throughout the network 200. This information may include, but is not limited to, paths taken by the packets and times associated with the transmission of the packets, such as times when the packets arrived at the nodes and times when the packets exited the nodes. The data store 300 may be implemented as memory, such as random access memory or the like. Other modules within the processing node 220 may be implemented as programs and stored in the same memory as the data store 300.

The processing node 220 may also include a synchronized time generator 304 that is configured to synchronize clocks in nodes throughout the network 200, such as to a global reference time per operational block 102 (FIG. 1). In some embodiments, the synchronized time generator 304 may be configured to synchronize clocks in two or more of the nodes in the network 200 that are configured to transfer packets. In some embodiments, the synchronizing may include executing synchronizing protocols that may include network time protocol (NTP). In other embodiments, the synchronizing protocols may include precision time protocol (PTP).

Both PTP and NTP provide time synchronization over packet-based networks, such as the network 200. Both protocols may use a hierarchical system for distributing time data. PTP uses a master-slave relationship and NTP uses a server-client mode. NTP uses a hierarchical structure with stratum 0 servers at the top, such as atomic clocks and GPS receivers. These stratum 0 servers provide reference time to stratum 1 servers, which in turn synchronize stratum 2 servers or nodes, and so forth. PTP, on the other hand, utilizes a master-slave hierarchy to synchronize time, wherein a grandmaster clock sends a series of synchronization messages that allow node clocks to adjust for network latency. The accuracy of NTP may be in the millisecond to sub-millisecond range and the accuracy of PTP may be in the sub-microsecond range.

A processor 310 may be included in the processing node 220 and may be configured to execute one or more modules of the processing node 220. The processor 310 may also be configured to transmit instructions to the network 200, such as to specific nodes in the network 200. The modules described herein may be implemented as software, hardware, and/or firmware and may be executed by the processor 310. The modules described herein are examples of modules that may be executed by the processor 310. In other embodiments, the processor 310 may execute fewer or more modules. The modules are described briefly with respect to FIG. 3 and are described in greater detail with respect to other network embodiments described herein. In some embodiments, the modules may be stored and/or executed outside of the processing node 220, such as by an external server or the like.

A hop-to-hop latency calculator 312 may be a module executable by the processor 310. The hop-to-hop latency calculator 312 may receive packet location and timing data stored in the data store 300 and may process the data. Hop-to-hop refers to packets transferred from one node to an adjacent node (e.g., between a pair of adjacent nodes). In other embodiments, hop-to-hop refers to packets transferred between nodes that are configured to measure or stamp time and/or paths taken by the packets per operational block 108 (FIG. 1). The hop-to-hop latency calculator 312 may calculate times or latency for packets transferring between nodes in the network 200. As described in greater detail herein, the hop-to-hop analysis may provide exact locations where the network 200 is encountering high latency and/or low latency. In some embodiments, the hop-to-hop latency calculator 312 may analyze the latency to determine if unexpected increases or decreases in latency have occurred at specific locations in the network 200. In some embodiments, the hop-to-hop latency calculator 312 may be located external to the processing node 220.

A path analyzer 314 may be another module within the processing node 220 and maybe executable by the processor 310. The path analyzer 314 may determine paths taken throughout the network 200 by certain packets. In some embodiments, the path analyzer 314 may analyze data stored in the data store 300 to determine paths taken by the packets. The path analyzer 314 may analyze paths taken by packets, transmitted via connectionless transmissions, which are packets transmitted between nodes, but without handshakes or the like being performed. The devices and methods described herein may stamp the packets transmitted via connectionless transmissions with location and/or time data, which may be stored in the data store 300. Based on the location and/or time data, the path analyzer 314 may determine paths the packets transmitted via connectionless transmissions have taken and latency encountered on these paths.

A point-to-point latency calculator 316 may be another module within the processing node 220 and may be executable by the processor 310. The point-to-point latency calculator 316 may calculate latency between two distant points or nodes within the network 200. The two points may have one or more nodes in paths between the two points. For example, the point-to-point latency calculator 316 may calculate latency between the origination node 202 and the destination node 204 or along any of the paths 206 in the network 200. The point-to-point latency calculator 316 may calculate the latency by analyzing data stored in the data store 300. In some embodiments, the point-to-point latency calculator 316 may be located external to the processing node 220.

In some embodiments, the processing node 220 may include a security breach analyzer 320 that may be executable by the processor 310. The security breach analyzer 320 may analyze the latency within the network 200 to determine if anomalies exist that may be due to packets being diverted to be copied or otherwise used maliciously. In some embodiments, the security breach analyzer 320 may analyze the data stored in the data store 300 and/or outputs of the hop-to-hop latency calculator 312, the path analyzer 314, and/or the point-to-point latency calculator 316 to determine if latency exceeds a predetermined value, which may be indicative of packets being diverted for malicious purposes. In some embodiments, the security breach analyzer 320 may be located external to the processing node 220.

In some embodiments, the security breach analyzer 320 may measure a hop-to-hop time between a first node and a second node in a path from the origination node to the destination node. The security breach analyzer 320 may compare the measured hop-to-hop time to a predetermined time. The predetermined time may be an expected hop-to-hop time, such as a time input by a user or derived by one or more modules in the processing node 220. In some embodiments, the predetermined time may be a running average of hop-to-hop times between the first node and the second node. The security breach analyzer 320 may provide an indication that a security breach may be present in the path from the first node to the second node in response to the measured hop-to-hop time exceeding the predetermined time. In other embodiments, the indication may indicate that a security breach may be present in the first node or the second node in response to the measured hop-to-hop time exceeding the predetermined time. In some embodiments, the security breach indication may be provided if the hop-to-hop time increases, which may be indicative of malicious actions on the network 200.

In some embodiments, the security breach analyzer 320 may analyze paths taken by packets to determine whether security risks are present in the network 200. In such embodiments, the security breach analyzer 320 may analyze location information stored in the data store 300. In some embodiments, the security breach analyzer 320 may store at least one predetermined node that packets are expected to travel through between a first node and a second node, which may be the origination node 202 and the destination node 204. The security breach analyzer 320 may compare the nodes the packet travelled through to the at least one predetermined node. The security breach analyzer 320 may provide an indication that a security breach may be present in a path from the originating node to the destination node travelled by the packet in response to the packet travelling through a node that is not one of the predetermined nodes.

In some embodiments, the security breach analyzer 320 may indicate that an anomaly exists in the network 200 if the above-described situations are determined. For example, if the hop-to-hop time increases, the security breach analyzer 320 may provide an indication that an anomaly exists, wherein the anomaly may be a security breach. In other embodiments, the anomalies may be due to poor connections between nodes or failing or congested nodes.

The processing node 220 may include a packet location stamp generator 324 and a packet time stamp generator 326 that are executable by the processor 310. The packet location stamp generator 324 may generate instructions that cause the nodes in the network 200 or in the web of nodes to stamp location information on the packets as described herein. The packet time stamp generator 326 may generate instructions that cause the nodes of the network 200 to stamp time information on the packets as described herein. The packet location stamp generator 324 and/or the packet time stamp generator 326 may function per operational block 106 of FIG. 1.

Additional reference is made to FIG. 4, which illustrates a detailed example of the network 200 showing a plurality of nodes 400. The network configuration of FIG. 4 is an example of one of many different network and path configurations that may form the network 200. In the embodiment of FIG. 4, the first path 208 may include a first node N1, a second node N2, and a third node N3. The second path 210 may include a fourth node N4, a fifth node N5, and a sixth node N6. The third path 212 may include a seventh node N7 and an eighth node N8. In some embodiments, different paths may include overlapping nodes. For example, in other embodiments, the first path 208 and the second path 210 may share a common node.

The nodes 400 may be devices that transfer data, such as data packets. The nodes 400 may include, but are not limited to, routers, switches, bridges, servers, modems, and internet of things (IOT) devices. The paths 206 may change depending on the applications transferring data and the like. For example, the origination node 202 may specify certain paths for packets used to execute a specific application. In these situations, the nodes 400 may establish handshakes or the like to determine that the packets have been transmitted between specific nodes. In connectionless packet transmissions, the packets may take unknown paths. However, methods and devices described herein may enable these paths to be determined and analyzed.

With additional reference to operational block 102 of the method 100 shown in FIG. 1, methods described herein may commence with the synchronized time generator 304 (FIG. 3) generating and/or transmitting instructions that synchronize clocks in the nodes 400 with a time reference as described herein. For example, NTP or PTP may be used for the synchronization. The synchronization ensures that all the nodes 400 record or stamp packets as described herein using the same time reference, which reduces errors in the latency measurements and/or calculations.

In operational block 106 stamp/flow identification instructions are generated. These instructions may be generated and transmitted to the nodes 400 by the packet location stamp generator 324 and the packet time stamp generator 326. The instructions enable the nodes 400 to append time and/or location stamps to the packets as described herein.

In operational block 108 of FIG. 1, the nodes 400 in the network 200 may perform network-level sampling, which includes stamping the packets as described herien. Stamping may refer to stamping packets with times when the packets are acted on by the nodes 400, such as when the packets are received within or transmitted from nodes 400. Sampling may also include stamping location indicating where in the network 200 the actions occurred or where in the network 200 the packets were at a specific time. For example, latency can be measured as the packets transfer between nodes 400 or through the nodes 400. The network-level stamping provides for an accurate representation of network activity and may eliminate the need for ping/icmp. The sampling may also alleviate the need for ping measurements of time between transmissions and returns of a data packets.

An example of tracking a packet is illustrated in FIG. 4 with the time notations along the first path 208. A stamp/flow identification mechanism may be generated to identify and track certain packets as the packets travel throughout the network 200 as described with reference to operational block 108. In the example of FIG. 4, a packet may be transmitted from the origination node 202 to the destination node 204 via the first path 208, which includes hops via first node N1, the second node N2, and the third node N3. Because clocks in all the nodes are synchronized, the times at which the packet interacts with the nodes in the first path 208 may be accurately measured. The packet may be time stamped as having left the originating node at a time t1 and arriving or being processed by the first node N1 at a time t2. The packet may then be timestamped with time t3 as it leaves the first node and timestamped with a time t4 when it arrives and/or is processed by the second node N2. The timestamping may continue until the packet reaches its destination at the destination node 204.

The path taken by the packet and the times between each of the nodes may be transmitted to the processing node 220 where the data may be stored in the data store 300. A hop-by-hop analysis may be performed by the hop-to-hop latency calculator 312 to determine the time the packet took to transfer between nodes stamped to the packet as described in operational block 110 of FIG. 1, which may be referred to as a latency calculation or measurement. The same process may be applied to packets traveling via other paths, such as the second path 210 and the third path 212, or between other nodes in the network 200. Thus, the hop-to-hop latency calculator 312 may be able to calculate latency between certain nodes, such as between the first node N1 and the second node N2. The hop-to-hop latency calculator 312 may also be able to calculate the latency through specific nodes, such as through the second node N2. The results of the hop-to-hop latency calculator 312 may be stored in the data store 300 or other memory device. In some embodiments, latency and paths taken by packets may be determined at least in part on the time and/or location information stamped to the packets.

In some embodiments, a user or a program may cause packets to be transmitted between specific locations in the network 200 to determine latency in specific portions of the network 200. For example, if the processing node 220 needs to know latency associated with travel between the fifth node N5 and the third node N3, the processing node 220 may generate instructions causing a node in the network 200 to transmit a packet between the fifth node N5 and the third node N3. The latency and location data may then be sent to the data store 300 as described herein. The hop-to-hop latency calculator 312 may then determine latency between the nodes. In other embodiments, the point-to-point latency calculator 316 may determine latency between the origination node 202 and the destination node 204 or other distant nodes in the network 200.

The network 200 may be used to transmit packets that are application specific, such as specific to artificial intelligence or machine learning applications. In such embodiments, the processing node 220 may generate instructions that cause the nodes 400 to track packets related to certain applications. In some embodiments, the processing node 220 may cause the origination node 202 to generate specific packets or sample packets related to an application being executed on the origination node 202 or processed by the origination node 202. The processing node 220 is then able to determine paths taken by these packets and latency incurred during transfer of these packets. The processing node 220 may then direct traffic or analyze latency as described herein specific to the applications.

Some packets or packet transmission protocols use connectionless protocols or transmission techniques to transfer packets. In connectionless protocols, the packets are transmitted to destinations without requiring handshakes or the like. Thus, the packets may or may not be successful in reaching the destinations and the paths taken by these packets are unknown. By using the devices and methods described herein, including the path analyzer 314, the locations and times at the locations of the packets transmitted via connectionless protocols can be determined and received in the data store 300 for processing as described herein.

The latency determined within the network 200 may be used for many purposes. For example, if the processing node 220 determines that a specific hop or a specific portion of the network 200 is experiencing high latency, the processing node 220 may transmit instructions that cause packets to avoid that portion of the network 200. In a similar manner, if the processing node 220 determines that a hop or a specific portion of the network 200 is experiencing low latency, the processing node 220 may transmit instructions that cause that portion of the network 200 to be utilized more.

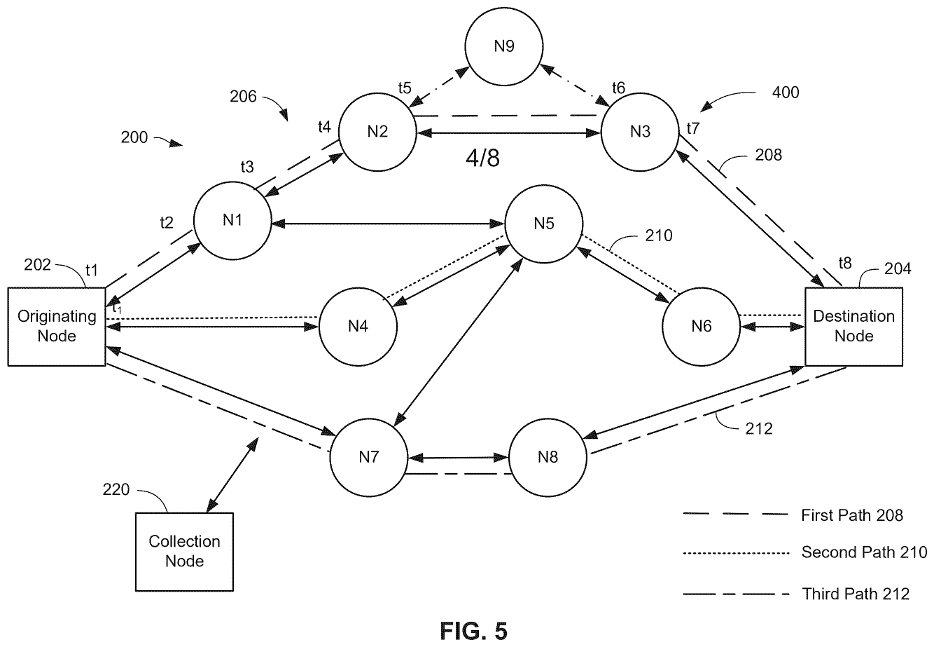

Additional reference is made to FIG. 5, which illustrates an embodiment of the network 200 wherein a node N9 is coupled to the network 200. The node N9 may represent a security risk and may serve malicious purposes such as diverting packets or certain packets transmitted by way of the network 200. As shown in FIG. 5, normal traffic transmitted via the first path 208 passes between the second node N2 and the third node N3. The processing node 220 is able to record expected latency times and the hops of packets using this path.

In the embodiment of FIG. 5, the node N9 may divert certain packets to the node N9. In other embodiments, malicious code or the like executed on one or more nodes may cause the packets or certain packets to divert to the node N9. The node N9 may then copy the packets or change data in the packets for malicious purposes. The security breach analyzer 320 (FIG. 3) may detect an increase in latency between the second node N2 and the third node N3. The security breach analyzer 320 may also detect that some or all packets transmitted via the first path 208 are now passing through the node N9, which may not be a predetermined node as described herein. In response to these anomalies, the processing node 220 may generate a signal indicating that a possible security risk or breach exists. The signal may include information describing where in the network 200 the security breach is located. In some embodiments, the processing node 220 may generate instructions that cease traffic to the node N9 or between the second node N2 and the third node N3.

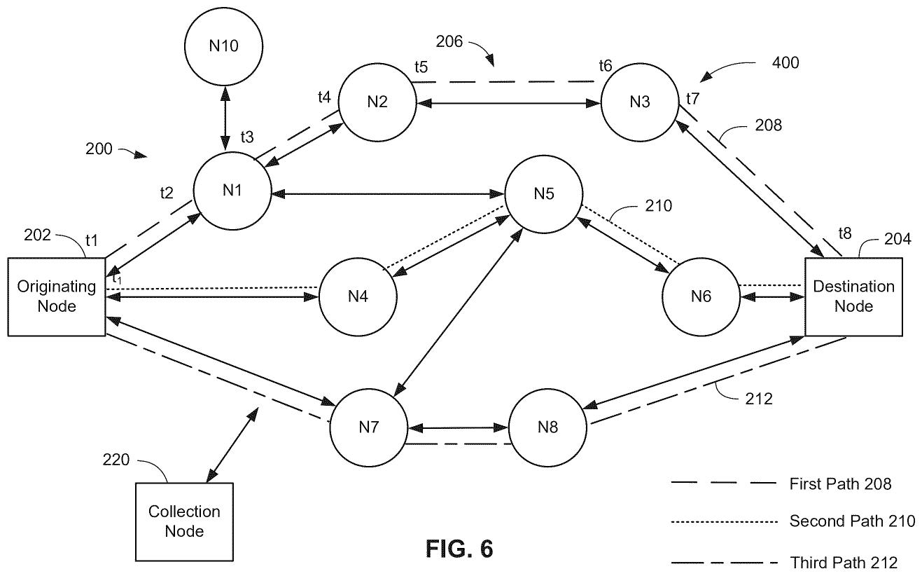

Additional reference is made to FIG. 6, which illustrates the network 200 with a node N10, wherein the node N10 may be configured to copy packets transferred via node N1 or via the first path 208. Malicious code may be executed on the first node N1 that causes processing, such as copying of packets or certain packets passing through the first node N1. The security breach analyzer 320 in the processing node 220 may detect that latency through the first node N1 has increased or increases when certain packets pass through the first node N1. In other embodiments, the security breach analyzer 320 may determine that the latency has exceeded a predetermined time. The increased latency may be due to processing, such as copying the packets and transmitting the copies to the node N10. In response to these anomalies, the processing node 220 may generate a signal indicating that a possible security risk or breach exists. The signal may include information describing where in the network 200 the security breach is located. In some embodiments, the processing node 220 may generate instructions that cease traffic to the node N1.

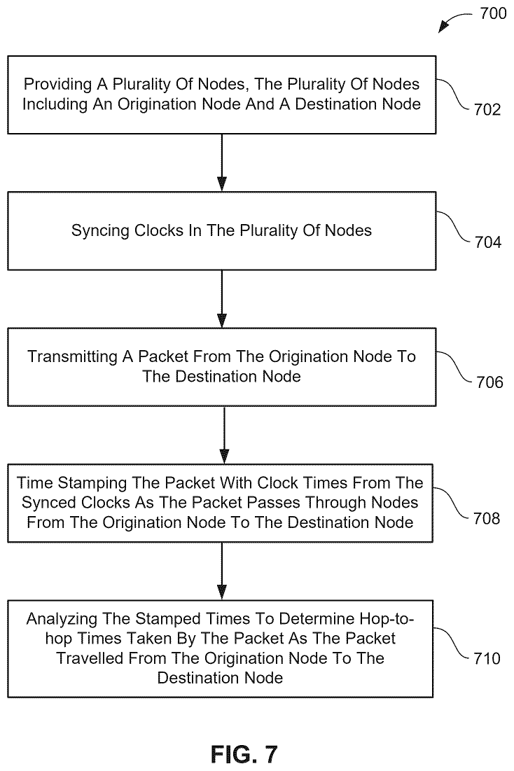

Reference is made to FIG. 7, which is a flowchart illustrating a method 700 of determining latency in a network (e.g., network 200). The method 700, at operational block 702, includes providing a plurality of nodes (e.g., nodes 400), the plurality of nodes including an origination node (e.g., origination node 202) and a destination node (e.g., destination node 204). The method 700 includes, in operational block 704, synchronizing clocks in the plurality of nodes. The method 700 includes, in operational block 706, transmitting a packet from the origination node to the destination node. The method 700 includes, in operational block 708, time stamping the packet with clock times from the synchronized clocks as the packet passes through nodes from the origination node to the destination node. The method 700 includes, in operational block 710, analyzing the stamped times to determine hop-to-hop times taken by the packet as the packet travelled from the origination node to the destination node.

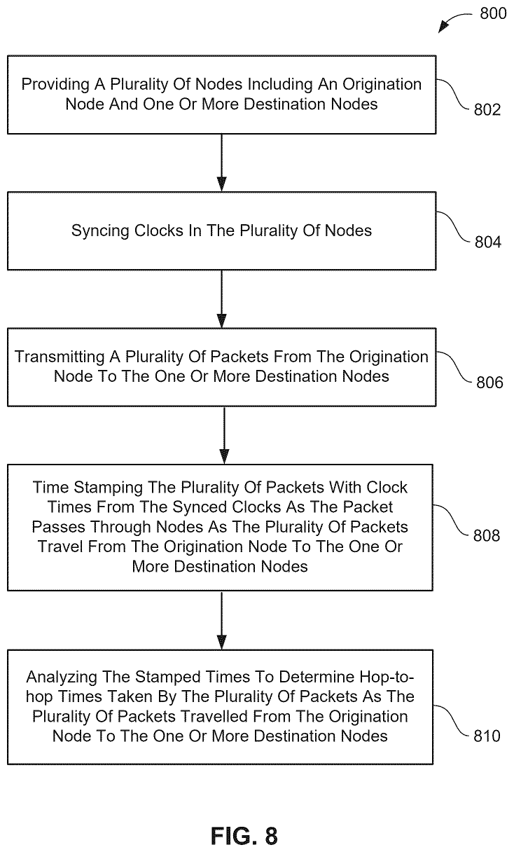

Reference is made to FIG. 8, which is a flowchart illustrating a method 800 of determining latency in a network (e.g., network 200). The method 800 includes, in processing block 802, providing a plurality of nodes (e.g., nodes 400) including an origination node (e.g., origination node 202) and one or more destination nodes (e.g., destination node 204). The method 800 includes, in processing block 804, synchronizing clocks in the plurality of nodes. The method 800 includes, in processing block 806, transmitting a plurality of packets from the origination node to the one or more destination nodes. The method 800 includes, in processing block 808, time stamping the plurality of packets with clock times from the synchronized clocks as the packet passes through nodes as the plurality of packets travel from the origination node to the one or more destination nodes. The method 800 includes, in processing block 810, analyzing the stamped times to determine hop-to-hop times taken by the plurality of packets as the plurality of packets travelled from the origination node to the one or more destination nodes.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the principles and novel features disclosed herein.

What is claimed is:

1. A method of determining latency in a network, the method comprising:
providing a plurality of nodes, the plurality of nodes including an origination node and a destination node;
synchronizing clocks in the plurality of nodes;
transmitting a packet from the origination node to the destination node;
time stamping the packet with clock times from the synchronized clocks as the packet passes through nodes from the origination node to the destination node; and
analyzing the stamped times to determine hop-to-hop times taken by the packet as the packet travelled from the origination node to the destination node.

2. The method of claim 1, further comprising transmitting the stamped times to a processing node, wherein the processing node is not a node the packet travelled through.

3. The method of claim 1, further comprising:
measuring a hop-to-hop time between a first node and a second node in a path from the origination node to the destination node;
comparing the measured hop-to-hop time to a predetermined time; and
providing an indication that a security breach may be present in the path from the first node to the second node in response to the measured hop-to-hop time exceeding the predetermined time.

4. The method of claim 3, wherein providing an indication comprises providing an indication that a security breach may be present in the first node or the second node in response to the measured hop-to-hop time exceeding the predetermined time.

5. The method of claim 1, further comprising stamping the packet with nodes the packet travels through between the origination node and the destination node.

6. The method of claim 5, further comprising:
comparing the nodes the packet travelled through to at least one predetermined node; and
providing an indication that a security breach may be present in a path from the originating node to the destination node travelled by the packet in response to the packet travelling through a node that is not one of the predetermined nodes.

7. The method of claim 1, wherein the packet is transmitted by way of connectionless transmission.

8. A method of determining latency in a network, the method comprising:
providing a plurality of nodes including an origination node and one or more destination nodes;
synchronizing clocks in the plurality of nodes;
transmitting a plurality of packets from the origination node to the one or more destination nodes;
time stamping the plurality of packets with clock times from the synchronized clocks as the packet passes through nodes as the plurality of packets travel from the origination node to the one or more destination nodes; and
analyzing the stamped times to determine hop-to-hop times taken by the plurality of packets as the plurality of packets travelled from the origination node to the one or more destination nodes.

9. The method of claim 8, further comprising transmitting the stamped times to a processing node, wherein the processing node is not a node the packet travelled through.

10. The method of claim 8, further comprising:
measuring a plurality of hop-to-hop times between a first node and a second node; and
providing an indication that an anomaly is present in the network in response to an increase in the measured hop-to-hop times between the first node and the second node.

11. The method of claim 10, wherein providing an indication comprises providing an indication that a security breach is present in the network in response to an increase in the measured hop-to-hop times between the first node and the second node.

12. The method of claim 10, wherein providing an indication comprises providing an indication that a security breach is present in the first node or the second node in response to an increase in the measured hop-to-hop times between the first node and the second node.

13. The method of claim 8, further comprising stamping the plurality of packets with nodes the plurality of packets travel through between the origination node and the one or more destination nodes.

14. The method of claim 13, further comprising:
comparing the nodes the packets travelled through to at a first destination node; and
providing an indication that an anomaly is present in a path from the origination node to the first destination node in response to a packet travelling through a node that is not a predetermined node between the origination node and the first destination node.

15. The method of claim 14, wherein providing an indication comprises providing an indication that a security breach is present in the path from the origination node to the destination node in response to the packet travelling through a node that is not a predetermined node between the origination node and the first destination node.

16. The method of claim 8, wherein the plurality of packets are transmitted by way of connectionless transmission.

17. A processing node for monitoring a network, the processing node comprising:
a synchronized time generator configured to synchronize nodes in a network to a global time reference;
a packet time stamp generator configured to cause one or more nodes of the network to time stamp one or more packets based on the global time reference as the one or more packets travel throughout the network; and
an analyzer configured to determine hop-to-hop time between at least one pair of nodes based at least in part on the time stamps.

18. The processing node of claim 17, wherein the synchronized time generator uses a network time protocol (NTP) to synchronize the nodes to a global time reference.

19. The processing node of claim 17, wherein the synchronized time generator uses a precision time protocol (PTP) to synchronize the nodes to a global time reference.

20. The processing node of claim 17, wherein the analyzer is configured to determine hop-to-hop times between each node between an originating node and a destination node.

21. The processing node of claim 17, further comprising a security breach analyzer configured to analyze the hop-to-hop time and determine whether a security breach exists in at least one of the nodes of the pair of nodes in response to the hop-to-hop time exceeding a predetermined time.

22. The processing node of claim 17, further comprising a packet location stamp generator configured to cause one more nodes of the network to stamp one or more packets with location information as the one or more packets travel throughout the network, and wherein the analyzer is further configured to determine paths travelled throughout the network by the one or more packets based at least in part on the location information.

23. The processing node of claim 22, wherein one or more of the packets are transmitted via connectionless communications.

24. The processing node of claim 17, further comprising a security breach analyzer configured to analyze locations of the one or more packets and determine whether a security breach exists in the network in response to one or more packets traveling through a node is not a predetermined list of nodes.
